(19) United States
(12) Patent Application Publication
(10) Pub. No.: US 2011/0063277 A1
(43) Pub. Date: Mar. 17, 2011

(54) ELECTRONIC PROTECTIVE MEASURES FOR ORGANIC DISPLAYS IN SMALL MEDICAL INSTRUMENTS

(76) Inventors: Andreas Menke, Mannheim (DE); Wolfgang Heck, Frankenthal (DE)

(21) Appl. No.: 12/718,196

(22) Filed: Mar. 5, 2010

Related U.S. Application Data
(63) Continuation of application No. PCT/EP2008/061571, filed on Sep. 2, 2008.

(30) Foreign Application Priority Data
Sep. 6, 2007 (EP) EP 07115802.6

(51) Int. Cl. G09G 5/00

(52) U.S. Cl. 345/212

(57) ABSTRACT

A medical instrument is proposed, having an electrical power supply and a display device for visually displaying information. The display device comprises a display with at least one organic light-emitting material and is designed to be supplied with electrical power by means of the electrical power supply. The display device furthermore comprises a drive apparatus, for driving the display, as well as a display driver. The drive apparatus is designed to drive the display in a regular operating mode in order to display the information. The drive apparatus comprises a protective circuit which is designed to monitor an electrical signal, which is provided by the electrical power supply, and to switch the display device to a safe state in the event of any discrepancy of the electrical signal from a standard range.

### CLAIM OF PRIORITY

The present application is a continuation application based on and claiming priority to International Application No. PCT/EP2008/061571, filed Sep. 2, 2008, which claims priority to European Patent Application No. 07115802.6, filed Sep. 6, 2007, each of which are hereby incorporated by reference in their entireties.

### TECHNICAL FIELD OF THE INVENTION

The present invention relates to a medical instrument having an electrical power supply and a display device for visually displaying information. The invention also relates to a method for driving a display device. Display devices, methods and medical instruments such as these are used in particular in the field of medical diagnostics, for example in medical instruments for determining a blood glucose concentration, a lactate concentration or for coagulation measurements.

### BACKGROUND

For diabetics, it is an essential part of daily life to determine blood glucose concentrations and appropriate medication. In this case, the blood glucose concentration must be determined quickly and easily several times a day (typically two to seven times), in order to make it possible to take appropriate medical measures when necessary. In many cases, medication is in this case carried out by means of automatic systems, in particular so-called insulin pumps.

In order to no longer unnecessarily restrict the daily life of a diabetic, appropriate mobile instruments are frequently used, which should be easy to transport and to handle, thus allowing the blood glucose concentration to be measured without any problems, for example at work or else during spare time. Various mobile instruments are currently commercially available, some of which operate on the basis of different measurement methods, and using different diagnosis methods. By way of example, a first measurement method is based on an electrochemical measurement method, in which a blood sample is applied to an electrode coated with enzymes and mediators. Appropriate test strips for electrochemical measurement methods such as these are described, for example, in U.S. Pat. No. 5,286,362, the disclosure of which is hereby incorporate herein by reference. Other known measurement methods use optical measurement methods which, for example, are based on the capability of the substance to be detected to react with specific verification reagents, in which case the color of the reaction mixture changes. Systems for verification of such color reactions, and therefore for verification of the appropriate analytes, are known, for example, from CA 2,050,677, the disclosure of which is hereby incorporated herein by reference.

It has been found that, because of the general increase in illnesses as a result of ageing, diabetes frequently occurs in relatively old people. However, particularly in the case of relatively old people, the visual power, in particular in poor lighting conditions, is frequently restricted as a function of age. Furthermore, eye damage is a frequent form of the typical consequential damage caused by diabetes mellitus. In this case, diabetics in particular require display elements which can be read easily in the portable measurement instruments which are used for self-monitoring. Similar problems also occur with other types of illnesses, in which portable instruments are used for homecare concept purposes.

The portable medical systems which are currently commercially available, in particular portable glucose measurement instruments, typically use liquid crystal displays (LCDs) however, as display instruments for glucose measured values, warnings and information, date, time etc. Both segmented LCDs and so-called matrix LCDs are used in this case. Segmented LCDs are predominantly used because of their low costs and the relative simplicity of their operation. Matrix LCDs are used in a small number of glucose measurement instruments, which are frequently high-quality instruments with comprehensive data management functions.

However, there are a number of disadvantages with regard to the legibility of liquid crystal displays. For example, in particular, liquid crystal displays are not self-illuminating. The liquid crystal elements in fact act only as “switches”, to switch local transparency on and off. However, the light must be provided by other means than the liquid crystal display itself. On the one hand, this can be done by reflecting environmental light onto a reflective surface behind the liquid crystal display and transmitting it through the liquid crystal display. However, in this case, the legibility of the liquid crystal display is highly dependent on the lighting intensity of the environmental light. In a dark environment or where the light is poor, liquid crystal displays can be read only with difficulty, if at all. A further disadvantage of the use of liquid crystal displays is that the legibility of the liquid crystal display, is highly dependent on the viewing angle (typically defined as the angle between a perpendicular to the display element and the viewing direction of an observer). This effect occurs both with and without additional background lighting. The freedom of use of the glucose measurement instrument by the diabetic is therefore greatly restricted. This is particularly disadvantageous since many diabetics use the glucose measurement instrument by placing it on a table top for measurement and operation. In this case, the situation can result in viewing angles at which the reading of the display is adversely affected, or is even impossible.

In addition to liquid crystal displays, a range of further display technologies are known. In particular, technologies are known which are based on the light emission from organic materials. Organic light-emitting diode (OLED) technology should be mentioned in particular here, and is used in various technical modifications. In organic light-emitting diodes, thin organic layers (one or more organic layers with an overall thickness of typically between 50 and 300 nm) are embedded between two electrodes. When an electric current is passed through the organic layers, then “holes” and “electrons” (or their organic pendants) recombine in the organic layers, in a similar manner to inorganic semiconductors. Photons are emitted during this recombination. This effect is referred to as organic electroluminescence.

Organic light-emitting diodes are normally in the form of thin-film systems on a transparent substrate, for example a glass or plastic substrate. In this case, electrode layers and organic layers are normally formed successively until the “sandwich structure” as described above is created. In this case, a transparent electrode layer is normally used as the first electrode layer (for example the anode layer), for example indium tin oxide. By way of example, a metal layer, for example calcium or magnesium, is used as the opposing electrode (normally the cathode). The “sandwich structure” is then appropriately encapsulated in order to protect the structure against the influence of air humidity and oxygen. In addition to this standard design as described, other embodiments are also known, for example embodiments with a plurality of OLEDs stacked on top of one another or embodiments in which emission does not take place through the glass substrate but through a transparent metal electrode layer. Furthermore, various technologies exist which differ with regard to the organic materials used. For example, technologies exist in which the materials are composed of (generally vapor-deposited) monomolecular substances. Other technologies use polymers as organic materials, which are generally applied wet-chemically. A person skilled in the art will also be aware of hybrid technologies.

Organic light-emitting diodes are now being used in various fields of technology. One example of this is mobile telephones, mixing panels in the audio area, displays for digital cameras, as well as MP3 players or multimedia players. Application examples also exist in the field of medical technology. For example WO 2004/048881 A2 and US 2003/0035109 A1, the disclosures of each of which are hereby incorporated herein by reference, describe systems in which organic light-emitting diodes are used as light sources. WO 2004/048881 A2 discloses among other things a measurement device for optical examination of a diagnostic test element using a light source, a photo detector and an apparatus for positioning the test element. The light source has one or more organic light-emitting diodes. US 2003/0035109 A1 discloses among other things a device for detection of organic molecules, in particular biomolecules or polymers, in which case the use of an OLED for lighting purposes is also proposed inter alia.

In addition to use as lighting means, applications of OLEDs as display elements are also known in medical technology. For example, US 2005/0015115 A1, the disclosure of which is hereby incorporated by reference, discloses among other things a first-aid system which has an output device. In this case, it is mentioned that the output device may also have an OLED display. U.S. Pat. No. 6,579,237 B1, the disclosure of which is hereby incorporated by reference, also discloses a medical system with an OLED display, among other things. This is a diagnostic ultrasound imaging system, which has an OLED display for displaying the ultrasound data.

However, one requirement for the use of OLED displays, which is known from other fields of technology, frequently results from the fact that the displays used have a comparatively short life and tend to be more susceptible to defects. In particular, this is because the organic materials used and/or the electrode materials used degrade over time. Furthermore, quality control is frequently difficult and, for example, the electrode materials used (for example reactive metals such as calcium or magnesium) have a tendency to oxidation effects. Furthermore, OLED displays are extremely sensitive to overvoltages or to other faulty electrical drives.

Overall, these effects result in individual pixels, individual rows or columns, and in some cases entire displays, failing gradually or else suddenly and unpredictably. However, a failure such as this is frequently associated with fatal consequences in particular in the case of medical instruments, in particular medical instruments which are used for self-monitoring and/or self-medication in the private field. For example, it is possible in particular that relatively old patients do not perceive faults that have occurred or, even if the faults are perceived, do not react correctly to these faults. By way of example this can lead to incorrect medication—with the known serious consequences. In particular, so-called segmented displays, for example seven-segment displays, have been found to be disadvantageous in this context since corruption of indicated values can easily occur as a result of unnoticed failure of individual segments. By way of example, a display “7” can easily become the display “1”, if the uppermost horizontal segment has failed. A defect such as this can have fatal consequences in displays used in the medical field.

The drive for displays such as these is particularly important with regard to increasing the life and other advantageous display characteristics. Numerous drive circuits for OLED displays are known from the prior art and, depending on the type of display, are intended to protect the display itself against failures. One example of a drive circuit such as this is disclosed in U.S. Pat. No. 7,193,589 B2, the disclosure of which is hereby incorporated by reference herein, which discloses among other things a drive circuit for active matrix OLED displays. Numerous further examples are known.

In many cases, the drive circuit for OLED displays comprises a display driver which generally controls the currents through the individual pixels of the display corresponding to the image data fed into this display driver. However, one problem of drive circuits such as these, in particular in the field of mobile instruments, is how to switch off the device. For example, it has been found that, if they are switched off abruptly or in other cases in which energy is abruptly drawn from the drive circuit, irregular states: can occur in which unregulated voltage and/or current states can occur. This problem is particularly evident in mobile devices when, particularly in the switched-on state, removable energy stores such as batteries or rechargeable batteries are removed. In addition, if the device is dropped on the ground and in the process the batteries or rechargeable batteries fall out of the device, the power supply collapses abruptly. In situations such as these of an abrupt collapse of the electrical power supply, the program procedure in the drive of the display can usually no longer guarantee the required timing, thus making it possible for the described unregulated voltage states to occur. This can in turn lead to destruction of the displays and/or of other circuit parts in the devices.

Thus, one object of the present invention is to provide a medical instrument for carrying out at least one medical function, which avoids the disadvantages of known medical instruments. In particular, the medical instrument is intended to include effective protection of the display, or of the displays contained therein, against unregulated voltage states when the power supply collapses.

### SUMMARY

This object and others that will be appreciated by a person of ordinary skill in the art have been achieved according to the embodiments of the present invention disclosed herein. In one embodiment, the present invention comprises a medical instrument and a method having the features of the independent claims. Advantageous developments of the invention which can each be implemented individually or in combination are specified in the dependent claims. All the claims are hereby included by reference in the content of the description.

According to embodiments of the present invention, a medical instrument is proposed having an electrical power supply and a display device for visual display of information. In this case, in one of the embodiments described in the following text, the display device may, however, in principle also be used on its own, that is to say independently of the medical instrument, for example in other types of devices with an electrical power supply, in particular in portable devices.

In this case, in principle, a medical instrument means any medical instrument which carries out at least one medical function. In this case, a medical function means a function which is used in some manner for therapeutic and/or diagnostic and/or surgical purposes. In particular, these may be diagnostic functions in the form of functions in which the concentration of at least one analyte, in particular of at least one metabolite, in a body fluid (for example in the blood and/or in tissue fluid) is determined qualitatively and/or quantitatively. Blood glucose measurements, cholesterol measurements, coagulation measurements, the determination of hormone levels or similar functions may be mentioned as examples here. For example, the medical instrument may comprise a blood glucose meter, in particular a portable blood glucose meter. Alternatively or additionally, the measurement functions may also comprise body functions, for example blood pressure measurements. Alternatively or additionally, the medical functions may, however, also comprise medication functions, for example the function of an injection of a specific amount of insulin. To this extent, the medical instrument may, for example, comprise a portable, automatic insulin injector and/or an insulin pump. Furthermore, the medical function may, for example, comprise a sampling function, for example a function for producing a liquid sample of a body fluid, for example of a blood droplet, for example by means of at least one lancet. In this case, the functions mentioned above may be implemented individually or else in any desired combination in the medical instrument. In certain embodiments, the medical instrument to be designed such that its weight and/or its dimensions are/is suitable for use as a portable medical instrument.

All the examples of medical instruments that have been mentioned may be associated with the need to graphically display at least one optical information item to a user. In the case of a portable analysis instrument, for example a blood glucose meter, these may be, for example, analysis results and/or menu functions for controlling the operation of the medical instrument. By way of example, in the case of a medication apparatus, this may be a selected amount of medication and/or menu functions for controlling the operation of the medical instrument. By way of example, in the case of a sampling apparatus, this may be information about the number of lancets that are still available and/or an insertion depth and/or menu functions for controlling the operation of the medical instrument. In particular, the medical instrument can be used to monitor health values at home within a homecare program and may be used, for example, for point, discrete measurements (for example at fixed predetermined times), or may comprise continuous monitoring.

In this case, a “display device” means any desired device which is designed to provide a user with information in a visual form. However, the display device described in the following text is described specifically in conjunction with use in a medical instrument. Nevertheless, in one or more of the embodiments described in the following text the display device, which can be supplied with electrical power from an electrical power supply, can in principle also be used in conjunction with other electronic devices, such as portable electronic devices. For example, it would be feasible to use one of the described embodiments of the display device for a mobile communication device for example, for instance a mobile telephone or a PDA (personal digital assistant, portable small computer). Other types of electronic devices, in particular portable electronic devices, can also advantageously be equipped with the described display device and profit from the advantages described in the following text.

In order to provide visual information, the display device comprises at least one display with at least one organic light-emitting material. This display may be any desired apparatus for displaying visual information, for example simple light spots, symbols, segment displays (for example seven-segment displays), matrix displays or other types of displays. The organic light-emitting material can also be used in the form of a simple background lighting for other types of display, for example by the display having a liquid crystal display with organic background lighting, for example a large-area OLED as background lighting. In a corresponding manner, the displayed information may also, for example, be in a binary form (simple on-off information, for example for lighted symbols), or for example may contain alphanumeric information, which is typically displayed on a segmented display or a matrix display. The display itself can comprise a passive matrix display, since the display device described in the following text particularly effectively protects displays such as this. However, alternatively or additionally, this does not preclude the use of other display operating modes or display structures, such as active matrix displays. Combinations of said display types are also possible.

The organic light-emitting material can be composed of polymers and/or alternatively low-molecular-weight organic materials. The display with the at least one organic light-emitting material is often in the form of an OLED display, for example according to the above description and/or according to one of the exemplary embodiments specified in the prior art. However, this does not preclude displays of a different type with organic light-emitting materials, for example displays in which organic light-emitting materials are embedded in inorganic emitter materials.

The display device is designed to be supplied with electrical power from the electrical power supply. The electrical power supply may in this case, for example, be directly integrated in the display device itself or, alternatively or additionally, may also be arranged externally and, for example, may be a component of the medical instrument which comprises the display device, in particular may be integrated in a housing of the medical instrument. The display device itself may then, for example, have appropriate interfaces or connections via which electrical power can be applied to the display device from the electrical power supply.

In this case, in principle, any desired types of power supplies such as these may be used. For example, the electrical power supply may comprise a power cable and/or an interface in order to provide an electrical voltage and/or an electric current externally, as may be advantageous, for example, for stationary laboratory devices. However, in other embodiments the electrical power supply can be matched to the mobility requirement for the medical instrument which has the display device, as a result of which it is typical to use a removable power supply. In particular, the electrical power supply may comprise one or more replaceable energy stores, for example a replaceable rechargeable battery and/or a replaceable battery. The replacement capability may in this case be ensured, for example, by appropriate flaps, slides, holders for the replaceable energy store or similar apparatuses, which may be provided on the display device itself and/or on the medical instrument (for example in a housing for it). In addition to supplying the display device, the power supply may also be used to supply other components or functions of the medical instrument, for example to supply power to a central controller for the medical instrument.

The display device furthermore has a drive apparatus for driving the display, which in turn has a display driver. This drive apparatus is designed to drive the display in a regular operating mode for displaying the information. In this case, a “regular operating mode” means a display device operating mode in which the drive apparatus has information data applied to it which is provided, for example, from a controller for the medical instrument and which is then displayed on command on the display or by the display. This is the normal mode of the display device or of the medical instrument, in which both elements are switched on.

A “display driver” means an electronic device which ensures that the image information is reproduced correctly on the display. Particularly in the case of an OLED display, or else for other types of displays, it is possible, for example, to design the display driver such that it controls the currents through at least one display pixel. Since the brightness of these pixels is in many cases at least approximately proportional to the current level, this allows the brightness of individual pixels to be specifically controlled. In this case, the display driver therefore provides current regulation for the individual pixels, for example current regulation for individual rows and/or columns in the display.

The drive apparatus may have further elements in addition to the at least one display driver (in the same sense, a plurality of such display drivers can also be provided, for example in order to control different areas of the display). These further elements may, for example, have passive and/or active electronic components. These further components may also have at least one data processing device, for example a microprocessor.

The drive apparatus can be formed on a local basis. By way of example, the at least one display driver may for this purpose be arranged in the immediate vicinity of the display, for example on a substrate (panel) of the display and/or on a supply line (e.g., flexi-cable) to this display panel. Further components of the drive apparatus may then be arranged in the immediate vicinity of the display driver, or, alternatively or additionally, may also be arranged remotely from this display driver, for example on a separate electronics board. This makes it possible to ensure optimum space utilization, as is particularly advantageous for mobile medical instruments.

To this extent, the display device may, for example, correspond to commercially available display devices. As described above, the problem with such display devices is, however, the possible, damage caused by unregulated voltage states, which can occur in particular if the electrical power supply fails abruptly. Particularly in the situation in which the display driver is arranged in the immediate vicinity of the display, for example on the display panel and/or on a flexible supply line to this display panel, it is technically very difficult to check that the drive between the display driver and the actual display is correct, without intervening in the hardware of the display driver (which for example may be in the form of an application-specific integrated circuit ASIC).

The invention therefore proposes that the drive apparatus have a protective circuit. This protective circuit may be entirely or partially integrated in the drive apparatus as an individual circuit, or may comprise a plurality of components. The protective circuit is designed to monitor an electrical signal which is provided by the electrical power supply, and to switch the display device to a safe state in the event of any discrepancy between the electrical signal and a standard range.

By way of example, the at least one electrical signal which is provided by the electrical power supply may comprise one or more electrical voltages and/or one or more electric currents. In particular, a voltage which is provided on the drive apparatus and/or the display driver and/or on the display may be monitored. In this case, the electrical signal which is provided by the electrical power supply may, for example, directly comprise a voltage and/or a current from the electrical power supply. In this case, “directly” means that the signal from the electrical power supply is monitored without the interposition of active and/or passive components, which have a considerable influence on the magnitude and/or a phase and/or a frequency of this signal. By way of example, when a DC voltage source such as a battery is used, it is possible, for example, to directly monitor a supply voltage from this DC voltage source. Alternatively or additionally, the electrical signal which is provided by the electrical power supply may, however, also be an indirect signal, for example a voltage-converted signal. For example a voltage converter (for example a DC/DC converter) may be accommodated between the electrical power supply and a microprocessor for the display device; and produces a supply voltage for the microprocessor, which is converted and/or is kept constant. This supply voltage can also be monitored as an “indirect” signal. Both the monitoring of electrical signals which are provided directly from the electrical power supply and the monitoring of “indirect” signals, that is to say signals which are derived from a direct signal with the interposition of active and/or passive components, are therefore possible and are intended to be covered by the present invention.

The monitoring process can be carried out in various ways. For example, it is possible to monitor whether the electrical signal is within at least one predetermined standard range which, for example, can be indicated in the form of a closed and/or open and/or half-open value interval. The electrical signal may, for example, be compared with one or more fixed nominal values or it is alternatively or additionally also possible to preset nominal values and/or standard ranges which vary over time, for example different standard ranges for different operating states on the display. The standard range also need not necessarily be constant over time and, for example, it is also possible in this sense to preset nominal value functions or standard range functions as a function of a time variable, which are compared with a time profile of the electrical signal.

Since, in particular, rapid falling power supplies can present problems, the at least one electrical signal could be compared with a threshold value, as a result of which the standard range is, for example, the range below or above this nominal value. For example, if the nominal value is a preset voltage A, the standard range may for example, cover all voltage values which are higher than A or which are greater than or equal to A or which are less than A or less than or equal to A. For example, it is possible to tell whether a preset minimum voltage has been undershot and/or whether a preset maximum voltage has been overshot. For example, it is also possible to detect overvoltages, leading to a change to the safe state. It is also possible to preset two voltage values A and B, where A<B, as nominal values, in which case the standard range for the voltage V may, for example, comprise A≦V≦B or A≦V≦B or A≦V≦B or A≦V≦B. Tolerance thresholds can also be preset in each case here.

In this case, the drive apparatus is designed such that it switches the display device to a safe state if there is any discrepancy from the standard range. The safe state may include one or more states as required, in which damage to the display is avoided. In this case, a “state” need not necessarily mean a mode which remains constant, that is to say a static mode, but a “state” may also mean a safety procedure or a programmed process. In particular, the safe state may comprise a driver voltage and/or a driver current for the display being switched off in a defined manner, with the display typically being designed such that no unregulated states can occur when it is switched off. This aspect will be described in more detail below, in the description of further exemplary embodiments. However, in principle, a safe state may be any desired state which differs from the regular operating mode and in which the occurrence of excessive currents and/or voltages on the display, in particular on individual pixels of the display, is avoided or impeded.

The proposed display device with the protective circuit therefore in general effectively prevents the possibility of unregulated display states occurring when the electrical power supply is suddenly interrupted, which states can damage the display (for example one or more pixels in a matrix display). For example, short-term overvoltages and/or excessive current loads on one or more pixels of the display can thus be avoided. This improves the protection of the display when the display device is switched off correctly, considerably increasing the life and reliability of the display device. Furthermore, even in the event of irregular switching off, for example when rechargeable batteries and/or batteries are withdrawn with the display device in the switched-on state or the display device is dropped and the batteries fall out, this prevents a briefly occurring unregulated state. The product quality and product life of the display device and/or of the medical instrument which comprises the display device are/is in this way considerably improved.

The display device can be developed advantageously in various ways. These developments of the invention and those which have already been mentioned can be implemented individually or in combination.

In particular, the protective circuit could be designed such that, in the event of an abrupt failure of the electrical power which is provided by the electrical power supply, the safe state ensures that operation of the display driver is maintained at least for as long as the display is supplied with electrical power. This ensures that the display is supplied with power in a regulated manner by means of the display driver until the final critical moment, that is to say for as long as the display itself has power applied to it. Unregulated states can therefore not occur in this case.

In the safe mode, it is also possible for at least one capacitive element to be discharged in a defined manner. Capacitive elements in the connection between the electrical power supply and the display and/or the display driver contribute significantly to the timing of a switching-off process since, for example, they (together with electrical resistances) govern time constants of a discharging process. By way of example, this makes it possible to guarantee the previously mentioned timing of the switching-off process, in which the display is operated in a regulated manner until the final moment. Furthermore, high voltages may still be present in particular on large capacitive elements long after the power supply has collapsed, which voltages are sufficient, for example, to continue to supply power to the display while, for example, the display driver has in contrast already been switched off. In this situation in particular, undefined, unregulated states can occur. The defined discharging of the capacitive element in the safe state makes it possible to prevent damage to the display device resulting from these unregulated states. By way of example, alongside or in addition to capacitors, the capacitive element may also comprise simple lines or other components on which a voltage can still be maintained after switching off.

In particular, the protective circuit may have at least one discharge switch in order to discharge the at least one capacitive element in a defined manner. This at least one discharge switch may, for example, be in the form of a transistor circuit and may be switched by the protective circuit or the drive apparatus such that it causes the at least one capacitive element to be discharged in a defined manner. In particular, the at least one capacitive element may in this case comprise a capacitive element between the power supply and the display driver. The discharge switch can be switched by a microprocessor, in particular a microprocessor for the drive apparatus. In this case, this microprocessor may carry out multiple functions and may, for example, also be used to control the display driver.

The at least one capacitive element may, for example, have two or more individual capacitive elements which, overall, result in smoothing of an electrical signal which is provided via the display supply path. It may also be possible to disconnect these two individual capacitive elements by means of a switch in the display supply path. For example, an electrical switch which is opened in the safe state may be integrated in the display supply path. For example, this switch can likewise be switched via the microprocessor, for example at the same time as, or with only a slight time offset with respect to, switching of the discharge switch. For example, both elements may be driven via an identical control line. This switch can therefore form a further component of the protective circuit. The discharge switch can disconnect the two individual capacitive elements such that, after the switch has been opened, only a small capacitance is still connected to the display driver, but in contrast a relatively large component of the capacitive element is disconnected from the display driver.

In one refinement, the electrical power supply provides electrical power for operation of the display via a display supply path. In this case, a “path” means one or more connections, in particular connecting lines which, for example, can carry electrical or optical signals. In this case, the capacitive element is integrated in this display supply path. Furthermore, in this embodiment, the electrical power supply is connected to the display driver via a driver supply path and provides electrical power for operation of this display driver. A driver capacitance is then integrated in the driver supply path, in which case this may once again also in the same sense comprise a plurality of capacitances. In this case, the capacitive element, the driver capacitance and the discharge switch are designed such that, when the electrical power supply is interrupted, the capacitive element, in the display supply path is discharged more quickly than the driver capacitance. In this case, “discharged more quickly” typically means a state in which the voltage which is present in the display supply path collapses before the voltage which is present in the driver supply path, that is to say falls below a minimum value required for the display supply earlier than the voltage which is present in the driver supply path falls below a minimum voltage which is required for operation of the display driver. In other words, this embodiment ensures that the display driver is not switched off at a time before, or is switched off only after display operation ceases, as a result of which display operation is regulated until the final moment. This allows the timing of the switching-off process to be defined precisely without unregulated states occurring on the display.

In order to prevent abrupt switching off of the electrical power supply also leading to undesirable discharging of the driver capacitance in a direction other than that via the display driver, it is also possible to accommodate one or more diodes in the driver supply path. For example, this diode can be accommodated between a first DC/DC converter and the driver capacitance, in order to prevent the driver capacitance from being discharged via the first DC/DC converter.

Furthermore, the display supply path may have a DC/DC converter. The driver supply path may also have a second DC/DC converter. These DC/DC converters can be designed to convert a voltage which is provided by the electrical power supply to the required Operating voltages for operation of the display driver and/or the drive apparatus and/or for operation of display. This allows the required nominal voltages also to be generated and kept constant from fixed voltage values, which are predetermined for example by specific batteries and/or rechargeable batteries.

In order to monitor the at least one electrical signal with the standard range and to find any discrepancy, the protective circuit may in particular have a comparator which, for example, compares a voltage which is provided by the electrical power supply and/or a current which is provided by the electrical power supply with the nominal value. This comparator, in which case a plurality of comparators may also be provided in the same sense, may have one or more discrete electronic modules. However, the comparator could be at least partially integrated in a microprocessor, such as a microprocessor for the drive apparatus. For example, the comparator may be entirely or partially in the form of software components, which run on the microprocessor, and/or hardware components which are integrated in the microprocessor.

If the at least one electrical signal is compared with one or more nominal values in order to find any discrepancy from a standard range, then the nominal value may, for example, be characterized by a reference voltage which is applied to the comparator. If relatively complex nominal values are desired, then this reference voltage may, for example, also comprise a plurality of individual reference voltages, one or more reference voltages which vary over time, or reference voltage functions as a function of time. This apparatus variant can be implemented easily particularly when integrated in a microprocessor. The reference voltage can be provided at least partially by the microprocessor since it generally provides defined voltage outputs. Alternatively or additionally, one or more of the reference voltages may be applied externally and may be provided, for example, by a constant-voltage source.

As described above, the protective circuit typically has a data processing device, in particular a microprocessor. This microprocessor or the data processing device may, in particular, be designed to carry out a drive program for driving the display. In addition to this data processing device, the medical instrument which has the display element may have further data processing devices, for example further microprocessors, which can carry out other functions, for example functions for analysis of a liquid sample (for example of a blood sample for blood glucose content). If a plurality of data processing devices, in particular microprocessors, are provided, then they can also be used in the master-slave mode, in which case, for example, at least one microprocessor for the protective circuit or for the drive apparatus may be used as a master, and a further microprocessor for the medical instrument can be used as a slave. An opposite configuration is also possible, in which the data processing device for the drive apparatus or the protective circuit is used as a slave.

In particular, the data processing device for the protective circuit or for the drive circuit may be designed to interrupt the drive program in the safe state, and to carry out a switching-off program. By way of example, this interruption may be in the form of an interrupt by means of which the drive program which operates the display in the regular operating mode is interrupted. For example, if it is found that the electrical signal which is provided by the electrical power supply has undershot a nominal value (for example a minimum voltage), then, for example, a flag (that is to say a specific operating variable, such as a Boolean operating variable) can be set to an interrupt value, and the interrupt can be used to interrupt the ongoing program execution of the regular drive program for the regular operating mode, and to switch to the switching-off program.

As described above, the data processing device for the display device, in particular for the drive apparatus and/or the protective circuit, can carry out further functions for the display device, or for the medical instrument. In one embodiment, the data processing device still also is designed to drive the display driver.

In one of the described embodiments which, as stated, can also be used independently of a medical instrument, the display device as described above is particularly suitable for use in medical instruments, in particular in portable blood glucose measurement instruments. The proposed display device therefore makes it possible to use the technically advantageous OLED displays, in which case the technical disadvantages of these display elements can be avoided or reduced by the proposed protective circuit. In consequence, the advantages of display elements of this type, in particular the wide viewing angle, the sharp contrast and the self-illuminating characteristics of such displays which, for example, do not require any background lighting, predominate.

In addition to the proposed medical instrument and the display device in one of the described embodiments, a method is also proposed for driving a display device for visual display of information. In particular, the display device may be a display device in one of the embodiments described above, as a result of which reference can be made to the above description with regard to optional method variants. The display device once again has a display with at least one organic light-emitting material, an electrical power supply and a drive apparatus for driving the display, as well as a display driver. When the display device is in the switched-on state, the display is driven in a regular operating mode in order to display the information. In this case, analogously to the above description, an electrical signal which is provided by the electrical power supply is monitored, and the display device is switched to a safe state in the event of any discrepancy from a standard range.

The invention is to be explained in more detail by the following figures and examples.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 shows one exemplary embodiment of a medical instrument having a display device;

FIG. 2 shows a block diagram of a first exemplary embodiment of a display device according to the present invention; and

FIG. 3 shows a block diagram of a second exemplary embodiment of a display device according to the present invention.

In order that the present invention may be more readily understood, reference is made to the following detailed descriptions and examples, which are intended to illustrate the present invention, but not limit the scope thereof.

### DETAILED DESCRIPTION OF EMBODIMENTS OF THE PRESENT INVENTION

The following descriptions of the embodiments are merely exemplary in nature and are in no way intended to limit the present invention or its application or uses.

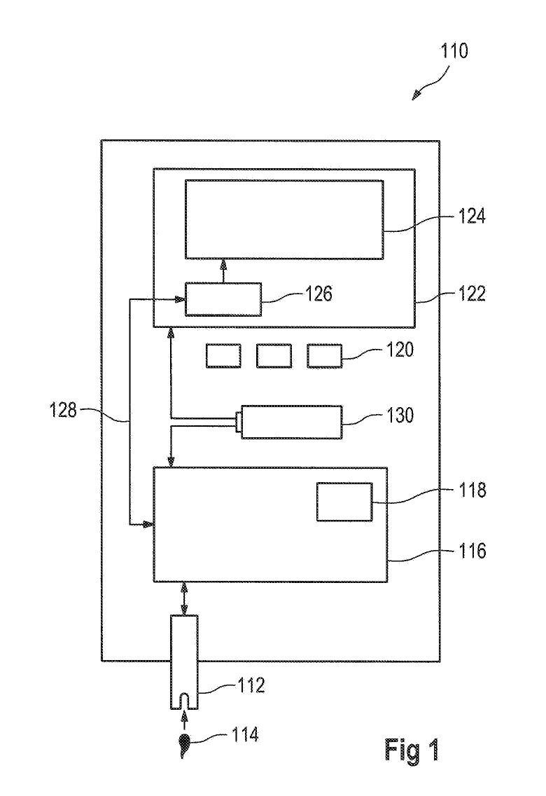

FIG. 1 schematically illustrates one possible exemplary embodiment of a medical instrument 110. In this exemplary embodiment, the medical instrument 110 is in the form of a portable hand-held instrument with a housing and is used, for example, for blood glucose measurement. For this purpose, the medical instrument 110 has an analytical test element 112. This analytical test element 112 is illustrated symbolically in FIG. 1 as a test strip to which a liquid sample 114 (a blood droplet) can be applied in order then to determine an analyte concentration, in the present case a blood glucose concentration, in the liquid sample 114 for example by means of an electrochemical and/or visual measurement method.

In order to evaluate the measurement, the medical instrument 110 also has a controller 116 which, for example, may have electronic components for evaluation of the blood glucose measurement. In one embodiment, the controller 116 has a microcomputer 118 in which, for example, appropriate software algorithms for evaluation of the measurement can run. Further functions, such as memory functions, input and output functions, database functions or the like may also be included.

Furthermore, the medical instrument 110 has a series of control elements 120 for controlling the functions of the medical instrument 110, as well as a display device 122. This display device 122 which is used for visual reproduction of information has a display 124 which, in the following text, is assumed to be an OLED display in this case. Alternatively or additionally, other types of display may also be provided, for example simple illuminated panels, symbols, battery state displays, etc. Furthermore, the following text assumes that the display 124 is a passive matrix display (without any restriction to the scope of the invention).

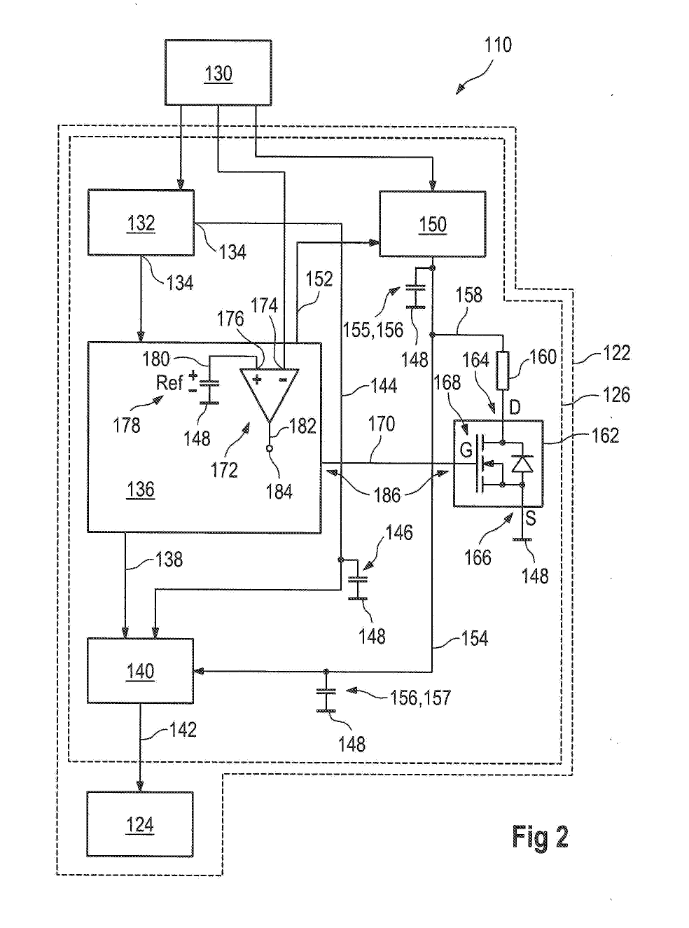

The display device 122 furthermore has a drive apparatus 126 for driving the display 124. This drive apparatus 126 is illustrated only symbolically in FIG. 1, and will be explained in more detail in the following text. The drive apparatus 126 is connected to the controller 116 via a data link 128, and can therefore interchange data. It should be noted that the drive apparatus 126 and the controller 116 may also be formed partially or entirely from identical components, for example by the controller 116 also carrying out the tasks of the drive apparatus 126. In this case, for example, the controller 116 may have a large and powerful microprocessor, for example a microprocessor of the ATMega2561 type from ATMEL in San Jose, USA. Master-slave operation is also feasible between the controller 116 and the drive apparatus 126, for example by the controller 116 having a first microprocessor which acts as a master for a second microprocessor (see reference number 136 at the bottom of FIG. 2) for the drive apparatus 126. In the latter case, the second microprocessor may, for example, be of a somewhat smaller and less powerful design, since it has to carry out fewer tasks. For example, in the latter case, it is possible to use a microprocessor of the ATMega168 type.

Furthermore, the medical instrument 110 according to the exemplary embodiment of FIG. 1 has an electrical power supply 130 which can be a removable electrical power supply 130, for example one or more batteries and/or rechargeable batteries. The electrical power supply 130 in this exemplary embodiment as shown in FIG. 1 may, for example, supply power to the display device 122 and/or to the controller 116. Further system functions of the medical instrument 110 may also be supplied with power from the electrical power supply 130.

The medical instrument 110 illustrated in FIG. 1 is illustrated only symbolically and may be modified in various ways. For example, instead of using test strips as analytical test elements 112, it is also possible to use other types of test elements 112, for example analytical test tapes, small test tubes or the like. By way of example, the medical instrument 110 may be a tape recorder, in which the analytical test element 112 comprises a test tape with a multiplicity of individual test areas. Other types of medical instrument 110 are also feasible, for example combined medical instruments 110 with, for example, a piercing function and an analysis function, or other types of medical instruments, such as one or more of the medical instruments 110 listed by way of example above, for example blood pressure measurement instruments, systems for obtaining samples, medication instruments or else combined instruments with a plurality of functions (for example an integrated system for obtaining samples, with a blood glucose measurement instrument).

The display device 122 is also illustrated only in a highly schematic form in FIG. 1, with its elements. FIG. 2 shows one possible exemplary embodiment of a display device 122 such as this which, for example, can be used in the medical instrument 110 as shown in FIG. 1.

The display device 122 in FIG. 1 is supplied with electrical power by the electrical power supply 130. The electrical power supply 130 is connected to a first DC/DC converter 132. By way of example, the electrical power supply 1130 may comprise two series-connected batteries of about 1.65 V each, with the first DC/DC converter 132 being designed to maintain a constant voltage of about 3.3 V at its outputs 134.

Furthermore, the first DC/DC converter 132 is connected via its output 134 to a microprocessor 136 for the drive apparatus 126, and therefore supplies this with the constant voltage of about 3.3 V. The microprocessor 136 is in turn connected via a control line 138 to a display driver 140, which drives the display 124 via image lines 142, as a result of which the desired information is displayed.

The output 134 of the first DC/DC converter 132 is also connected via a driver supply path 144 to the display driver 140, as a result of which the display driver 140 likewise has the output voltage of, e.g., about 3.3 V from the first DC/DC converter 132 applied to it via this driver supply path 144. A driver capacitance 146 is integrated in the driver supply path 144 and is connected to ground 148 at one end.

The electrical power supply 130 is also connected to a second DC/DC converter 150. This DC/DC converter converts the voltage from the electrical power supply 130 of about 3.3 V to about 13 V in this exemplary embodiment, and keeps this voltage constant there. The second DC/DC converter 150 is connected to the microprocessor 136 via a control line 152, and can in this way be controlled by this microprocessor 136, that is to say in particular it can be switched on and off.

The second DC/DC converter 150 is connected to the display driver 140 via a display supply path 154, and in this way provides electrical power to operate the display 124, in contrast to the driver supply path 144 which provides electrical power, that is to say in particular a voltage, for control logic for the display driver 140.

A capacitive element 156 is integrated in the display supply path 154, in a similar manner to the driver supply path 144, and in this exemplary embodiment is formed from a first capacitive element 155, which is arranged between the DC/DC converter 150 and a tap for a discharge line 158 (see below), and a second capacitive element 157, which is arranged between the tap for the discharge line 158 and the display driver 140. The capacitive elements 155, 157 are connected to ground 148 at one end, analogously to the driver capacitance 146. By way of example, the first capacitive element 155 may have a capacitance of about 4.7 microfarads and the second capacitive element 157 may have a value of about 26.7 microfarads, as a result of which the capacitive element 156 has a total capacitance of about 31.4 microfarads. Other values are also feasible for the capacitances of the capacitive elements 155, 156, 157 or a different arrangement of these capacitive elements 155, 156, 157 (for example a different number of capacitive elements 155, 156, 157 and/or a different connection of these capacitive elements 155, 156, 157) and this can be identified and implemented by a person skilled in the art. The capacitive elements 155, 156, 157 jointly smooth an electrical signal which is provided via the display supply path 154. The driver capacitance 146 which is accommodated in the driver supply path 144 may, for example, have a capacitance of about 0.5 millifarads, which is considerably greater than the capacitance of the capacitive element 156 and, as will be described in more detail in the following text, means that the functionality of the display driver 140 is maintained for a longer time than the functionality of the display supply if the electrical power supply 130 is switched off abruptly, which means that no unregulated voltage and/or current states can occur in the supply for the display 124.

Furthermore, a discharge line 158 is tapped off from the display supply path 154 between the second DC/DC converter 150 and the display driver 140. This discharge line 158 connects the display supply path 154 via a discharge resistor 160 and a discharge switch 162 to the ground 148. By way of example, a value in the order of magnitude of about 39 ohms may be used for the discharge resistor 160, in conjunction with the capacitances mentioned above, or with a similar order of magnitude and distribution of the capacitances. This results in an RC time constant of about 1.2 milliseconds for the capacitive elements 155, 156, 157 to be discharged via the discharge resistor 160.

The discharge switch 162 is in the form of a transistor switch, whose input and output respectively represent the drain 164 and the source 166. The gate 168 of this discharge switch 162 is connected via a control line 170 to the microprocessor 136, thus allowing the discharge switch 162 to be switched by the microprocessor 136.

The drive apparatus 126 furthermore has a comparator 172. In this exemplary embodiment, this comparator 172 is a part of the microprocessor 136. A comparison input 174 of the comparator 172 is connected to the electrical power supply 130 such that, by way of example, an electrical voltage from the electrical power supply 130, for example about 3.3 V as mentioned above, is applied directly to this comparison input 174.

A reference input 176 is connected to a reference voltage source 178 which provides a reference voltage. This reference voltage 180 may, for example, be about 1.1 V. In the present exemplary embodiment, the reference voltage 180 is provided by an internal reference voltage of the microprocessor 136. Alternatively or additionally, however, comparators 172 with external reference voltages can also be provided.

The signal output 182 of the comparator 172 is connected to an interrupt input 184 of the microprocessor 136. In other words, an interrupt can be initiated by the output signal from the comparator 172. The components of the comparator 172 and the interrupt input 184 may be formed entirely or partially by the microprocessor 136 and may, for example, be implemented entirely or partially by software modules and/or by hardware components in the microprocessor 136.

By way of example, in the present exemplary embodiment, a combination of two. AAA batteries may be used as the electrical power supply 130, in order to produce the voltage of about 3.3 V. By way of example, an ATMegal68 processor from ATMEL in San Jose, USA may be used as the microprocessor 136, that is to say the display processor. The corresponding functions of this display processor can be used as a comparator 172 and reference voltage 180, which means that there is no need for any additional components. By way of example, a passive matrix OLED driver controller of the SSD 1325, SSD 1328 or SSD 0323 type from Solomon Systech Ltd., Glashütten, Germany may be used as the display driver 140. However, alternatively or additionally, other types of display drivers 140 may also be used. The display 124 may, for example, comprise a passive matrix polymer OLED display of the Pictiva brand from Osram Opto Semiconductors in Regensburg, Germany.

In this exemplary embodiment, the microprocessor 136 with the comparator 172, the control line 170, the discharge line 158, the discharge resistor 160 and the discharge switch 162 form components of a protective circuit 186 for the drive apparatus 126.

The method of operation of this protective circuit 186 and of the entire drive apparatus 126 illustrated in FIG. 2, as well as that of the display device 122 will be explained briefly in the following text. The problems of unregulated states in the drive for the display 126, as described above, occur in particular when the batteries for the electrical power supply 130 are removed from the medical instrument 110 when it is in the switched-on state or fall out, for example by being dropped. However, if the power supply is interrupted, the operating voltage, which is provided via the driver supply path 144 to the display driver 140, for the control logic of the display driver 140 may fall such that the control logic collapses and the display 124 can be operated in an undefined, unregulated state, while the power supply for the display 124, which is provided via the display supply path 154, is still largely maintained. The display 124 can be damaged, for example by overvoltages and/or overcurrents, by the latter power supply, which is now no longer regulated.

The solution to this problem, as illustrated in FIG. 2, is based on continuous monitoring of the battery voltage of the electrical power supply 130. This monitoring is carried out by comparison of the voltage, which is provided by the power supply 130, in the comparator 172 with a nominal value in the form of the reference voltage 180 and thus shows in good time that, on the one hand, the voltage supplies (OLED supply and general supply for the control electronics) cannot enter a state which can cause damage. On the other hand, the entire system is brought to a defined state which ensures smooth restarting (for example when another battery is inserted).

For this purpose, the comparator 172 continuously monitors the battery voltage applied to its comparison input 174 when the supply for the OLED display 124 is switched on. If the voltage dips below the reference voltage 180, that is to say for example below about 1.1 V±0.1 V, the comparator 172 sets a flag, that is to say an operating state variable which is provided for this purpose, and triggers an interrupt in the display processor 136. This interrupt immediately interrupts the ongoing program execution which is being carried out in the regular operating mode of the medical instrument 110 and of the display device 122, and now processes a switching-off program. This switching-off program contains a plurality of steps by means of which the display device 122 is brought to a safe, defined state, in which case, in addition, no unregulated states can occur during the switching-off process. In particular, the switching-off program can switch off the supply for the OLED display 124, can discharge the capacitive element 156 in the supply for the OLED display 124, and can switch off the entire system in a defined manner.

In this case, this monitoring should produce a trigger that is sufficiently early that the display processor 136 still has sufficient time to carry out the actions described above. By way of example, in the proposed circuit, about 20 to about 40 ms may be available, since the first DC/DC converter 132, which keeps the supply for the control electronics (that is to say the microprocessor 136 and the display driver 140) constant at about 3.3 V, typically continues to operate down to an input voltage of about 0.5 to about 0.8 V.

This therefore means that, when the supply voltage which is applied to the comparison input 174 and is provided by the electrical power supply 130 falls below about 1.1 V, the microprocessor 136 can carry out the switching-off program, in which the discharge switch 162 is switched via the control line 170. This switching operation results in an electrical connection between the drain 164 and the source 166 of this electrical switch 162. The capacitive element 156 is therefore discharged in a defined manner via the discharge resistor 160, as a result of which the electrical power supply for the display 124 is run down in a defined manner. In this case, the capacitances 146 and 156 as well as the discharge resistor 160 are of sizes such that this discharging of the capacitive element 156 takes place sufficiently quickly that the supply voltage which, in particular, is applied to the display driver 140 has not yet fallen to a minimum supply voltage at which this display driver 140 still operates. For example, as described above, this minimum supply voltage may be about 0.5 to about 0.8 V. Furthermore, optionally, the switching-off program may also comprise the second DC/DC converter 150 being switched off via the microprocessor 136 via the control line 152. These simple protective measures allow the life of the display 124 to be increased, and spontaneous failures of this display 124 can be avoided.

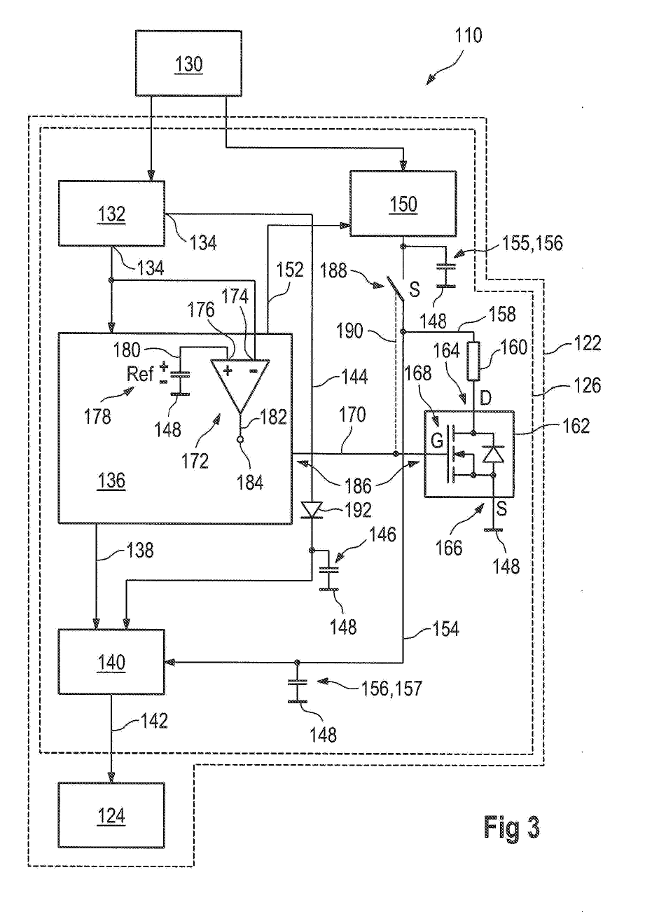

FIG. 3 shows a second exemplary embodiment of a: display device 122 which has been slightly modified from the exemplary embodiment shown in FIG. 2. The modifications from the exemplary embodiment shown in FIG. 2 can be implemented not only in combination, as illustrated in FIG. 3, but can also be implemented individually, as a person skilled in the art will be aware.

One major modification in comparison to the embodiment illustrated in FIG. 2, in the case of the display device 122 in FIG. 3, is that the comparator 172 does not directly monitor the signal which is provided by the electrical power supply 130, but monitors the supply signal which is provided from the first DC/DC converter 132 to the microprocessor 136. This indicates that, for the purposes of the present invention, although on the one hand it is possible to monitor the electrical signal which is provided by the electrical power supply 130 directly, that is to say without the interposition of further electrical elements, indirect monitoring is, however, also possible, with the interposition of further electrical elements. These further electrical elements should in this case be designed, however, such that the secondary signal produced by them (in this case as shown in FIG. 2 the supply signal, which is provided at the output 134 of the first DC/DC converter, for the microprocessor 136) makes it possible to deduce the signal from the electrical power supply 130.

This monitoring of the signal from the first DC/DC converter 132 by the comparator 172 can also be implemented in the exemplary embodiment illustrated in FIG. 2, in which a freely programmable comparator (for example of the ATMega168 processor) is used as the comparator 172. An alternative option, which allows the monitoring of the electrical power supply for the microprocessor 136 according to the exemplary embodiment shown in FIG. 3, also however comprises a so-called brown-out detector being used for the microprocessor 136, instead of a freely programmable comparator or some other comparator 172. A brown-out detector such as this is designed to monitor the fall of a supply voltage of a microcontroller, for example of a microprocessor of the ATMega2561 type. For this purpose, and in a similar manner to the design described in FIG. 2, this supply voltage is compared with a reference voltage from a reference voltage source 178 although in this case the reference voltages are normally not freely programmable but are preset in a fixed form by the microprocessor 136. However, otherwise, the circuitry is largely analogous to the exemplary embodiment described above with reference to FIG. 2, as a result of which, for example, an interrupt can also once again be triggered via the interrupt input 184.

The rest of the design of the exemplary embodiment in FIG. 3 is once again analogous to the exemplary embodiment shown in FIG. 2, which means that reference can largely be made to the above description. Once again, the capacitive element 156 has two individual capacitive elements 155, 157, with the first of these capacitive elements 155 being arranged upstream of the tap for the discharge line 158 in the display supply path 154 and with the second capacitive element 157 being arranged downstream from this tap. By way of example, in this exemplary embodiment, the first capacitive element 155 may assume a volume of about 150 microfarads, and the second capacitive element 157 a value of about 4.7 microfarads. This therefore results in the capacitive element 156 having a total capacitance of about 154.7 microfarads, which results in smoothing of the electrical signal which is provided via the display supply path 154.

FIG. 3 furthermore shows a further option for modification of the circuitry illustrated in FIG. 2 which elegantly solves a conflict of aims in the circuitry. For example, on the one hand, it is desirable to provide an electrical signal which is as smooth as possible via the display supply path 154 to the display driver 140 which means that the capacitive element 156 should be chosen to be as large as possible. On the other hand, however, this capacitive element 156, as described above with reference to FIG. 3, must be discharged quickly and reliably in the safe mode. The described high capacitance of about 154.7 microfarads and a discharge resistor 160 of, for example, about 100 ohms would result in this having an RC time constant of about 15 milliseconds, which is comparatively long. A modification of the circuitry is therefore implemented in FIG. 3, which splits the capacitive element 156 in the display supply path 154 by using a switch 188. This switch 188 is connected via a switching line 190 to the control line 170 (or to another control output of the microprocessor 136) and can therefore be switched via the microprocessor 136, at the same time as the switching, that is to say the closing, of the discharge switch 162. Thus, if a voltage drop is identified in the signal from the electrical power supply 130, then, as described above, an interrupt is triggered via the comparator 172, and the discharge switch 162 is closed. However, at the same time or with only a slight time offset, the switch 188 is also opened, as a result of which the first capacitive element 155 is disconnected from the display driver 140. However, this means that only the charge in the second capacitive element 157 now need be discharged via the discharge switch 162 via the discharge line 148, that is to say, for example, a capacitance of about 4.7 microfarads. With the discharge resistance of about 100 ohms, by way of example, as described above, this means that the capacitive element 157 now has a discharge time constant of only about 0.5 milliseconds (that is to say the part of the capacitive element 156 which is still available in the display supply path 154 upstream of the display driver 140), as a result of which the electrical power supply in the display supply path 154 collapses considerably more quickly, and unregulated voltage states and/or current states in the supply to the display 124 can be effectively avoided.

The driver capacitance 146 which is integrated in the driver supply path 144 may in the present exemplary embodiment assume a value of 150 microfarads, by way of example. It should be noted that this driver capacitance 146 may once again be formed from different capacitances, that other variables of the capacitances can be used, and that the circuitry may in general also differ from the circuitry illustrated in FIG. 3. As a further modification which can also be implemented with other exemplary embodiments of the display device 122 according to the invention, a diode 192 is integrated in the driver supply path 144 between the first DC/DC converter 132 and the driver capacitance 146. This diode 192 prevents the driver capacitance 146 from being able to be discharged via the driver supply path 144, which is connected above the diode 192 in FIG. 3, for example via the first DC/DC converter 132 and/or other components of the medical instrument 110 which are arranged here but are not illustrated, when the energy from the electrical power supply 130, which is provided via the driver supply path 144, collapses. In addition to the sizes of the capacitances which act while switching off (that is to say for example the relationship between the driver capacitance 146 and the second capacitive element 157), this protective measure also contributes to maintaining the functionality of the display driver 140 to the end when the electrical power falls abruptly, as a result of which it is impossible for any unregulated voltage and/or current states to occur at the display 124 before the switching-off process has been completed.

The features disclosed in the above description, the claims and the drawings may be important both individually and in any combination with one another for implementing the invention in its various embodiments.

It is noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the present invention in detail and by reference to specific embodiments thereof, it will be apparent that modification and variations are possible without departing from the scope of the present invention defined in the appended claims. More specifically, although some aspects of the present invention are identified herein as preferred or particularly advantageous, it is contemplated that the present invention is not necessarily limited to these preferred aspects of the present invention.

What is claimed is:

1. A medical instrument for carrying out at least one medical function comprising one of a therapeutic, diagnostic and surgical purpose, wherein the medical instrument has an electrical power supply and a display device for visually displaying information, wherein the display device comprises a passive matrix display in the form of an organic light-emitting diode display, the display device being powered by the electrical power supply via a display supply path, wherein the display device furthermore comprises a drive apparatus comprising a display driver configured to provide current regulation for individual pixels on the display, wherein the drive apparatus is designed to drive the display in a regular operating mode in order to visually display the information, wherein the drive apparatus further comprises a protective circuit configured to monitor an electrical signal which is produced by the electrical power supply and to switch the display device to a safe state if there is any discrepancy between the electrical signal and a predetermined standard range for the electrical signal, the protective circuit comprising at least one capacitive element and at least one discharge switch configured to discharge the capacitive element in a defined manner when in the safe state, wherein the at least one capacitive element is integrated in the display supply path and is connected to a ground at one end, the electrical power supply also providing electrical power for operating the display driver via a driver supply path, wherein a driver capacitance is integrated in the driver supply path and is connected to a ground at one end, wherein the capacitive element, the driver capacitance and the discharge switch are designed such that, in the event of an interruption in the electrical power supply, the capacitive element discharges more quickly than the driver capacitance, as a result of which a voltage applied in the display supply path falls below a minimum value required for the display supply faster than a voltage being applied in the driver supply path falls below a minimum voltage which is required for operating the display driver.

2. The medical instrument of claim 1, wherein the electrical power supply comprises a replaceable battery or a replaceable rechargeable battery.

3. The medical instrument of claim 1, wherein the electrical signal which is produced by the electrical power supply comprises a supply voltage.

4. The medical instrument of claim 3, wherein the supply voltage from the electrical power supply is detected directly.

5. The medical instrument of claim 3, wherein the electrical signal which is provided by the electrical power supply is produced by using a voltage converter to convert the supply voltage.

6. The medical instrument of claim 5, wherein the electrical signal which is provided by the electrical power supply is a supply voltage for a microprocessor.

7. The medical instrument of claim 1, wherein the protective circuit is designed such that the safe state in the event of an abrupt drop in the electrical power which is provided by the electrical power supply ensures that operation of the display driver is maintained for at least as long as the display is supplied with electrical power.

8. The medical instrument of claim 1, wherein the safe state comprises at least one of a driver voltage and a driver current for the display being switched off in a defined manner.

9. The medical instrument of claim 1, wherein in the safe state, at least one capacitive element is discharged in a defined manner, wherein the protective circuit comprises at least one discharge switch, and wherein the discharge switch can be switched for the defined discharging of the at least one capacitive element.

10. The medical instrument of claim 9, wherein the at least one capacitive element is switched between the electrical power supply and the display driver.

11. The medical instrument of claim 9, wherein the capacitive element comprises at least two individual capacitive elements.

12. The medical instrument of claim 9, wherein the discharge switch is driven by a microprocessor.

13. The medical instrument of claim 1, wherein the driver supply path comprises a DC/DC converter.

14. The medical instrument of claim 1, wherein the display supply path comprises a DC/DC converter.

15. The medical instrument of claim 14, wherein the safe state comprises the DC/DC converter being switched off.

16. The medical instrument of claim 1, wherein a diode is also arranged in the driver supply path and generally prevents the driver capacitance from being discharged in a direction other than via the display driver when the electrical power supply is switched off.

17. The medical instrument of claim 1, wherein a switch is integrated in the display supply path, and wherein the safe state includes the display supply path being interrupted by opening the switch.

18. The medical instrument of claim 17, wherein a capacitive element is integrated with at least two individual capacitive elements in the display supply path, wherein the two individual capacitive elements are disconnected by the switch.

19. The medical instrument of claim 18, wherein a first capacitive element, which is arranged between the electrical power supply and the switch, is larger than a second capacitive element, which is arranged between the switch and the display driver.

20. The medical instrument of claim 1, wherein the protective circuit has a comparator, and wherein the monitoring of the electrical signal which is provided by the electrical power supply comprises a comparison of the electrical signal with a nominal value.

21. The medical instrument of claim 20, wherein the comparator is at least partially integrated in a microprocessor.

22. The medical instrument of claim 20, wherein the protective circuit is designed to identify undershooting of the nominal value by the electrical signal as a discrepancy from the standard range.

23. The medical instrument of claim 20, wherein the nominal value is determined by a reference voltage which is applied to the comparator.

24. The medical instrument of claim 23, wherein the reference voltage is at least partially provided by a microprocessor.

25. The medical instrument of claim 1, wherein the protective circuit comprises a microprocessor configured to carry out a drive program for driving the display.

26. The medical instrument of claim 25, wherein the microprocessor is further configured to interrupt the drive program in the safe state and to carry out a switching-off program.

27. The medical instrument of claim 25, wherein the microprocessor is configured to drive the display driver.

28. A method for driving a display device for visually displaying information, comprising
providing a display device comprising a passive matrix display in the form of an organic light-emitting diode display, the display device further comprising a drive apparatus comprising a display driver for driving the display, the display driver being configured to provide current regulation for individual pixels of the display, wherein the display is driven in a regular operating mode in order to visually display the information;
powering the display device with an electrical power supply via a display supply path;
powering the display driver with the electrical power supply via a driver supply path for operating the display driver, the driver supply path comprising an integrated driver capacitance connected at one end to ground;
providing an electrical signal to the display device from the electrical power supply;
monitoring the electrical signal using a protective circuit comprising at least one capacitive element integrated in the display supply path and connected at one end to ground, the protective circuit further comprising at least one discharge switch configured to discharge the capacitive element in a defined manner when the display device is switched into a safe state, said monitoring comprising comparing the electrical signal to a predetermined standard range; and
switching the display device to the safe state in the event of any discrepancy of the electrical signal from the standard range for the electrical signal;
wherein the capacitive element, the driver capacitance and the discharge switch are designed such that, in the event of an interruption in the electrical power supply, the capacitive element discharges more quickly than the driver capacitance, as a result of which a voltage applied in the display supply path falls below a minimum value required for the display supply faster than a voltage being applied in the driver supply path falls below a minimum voltage which is required for operating the display driver.
